(19) United States
(12) Patent Application Publication
(10) Pub. No.: US 2024/0092210 A1
(43) Pub. Date: Mar. 21, 2024

(54) METHOD AND SYSTEM FOR PROVIDING ERROR HISTORY INFORMATION FOR ECO-FRIENDLY VEHICLE CHARGERS

(71) Applicants: Hyundai Motor Company, Seoul (KR); Kia Corporation, Seoul (KR)

(72) Inventor: Young Sik KIM, Anyang-si (KR)

(73) Assignees: Hyundai Motor Company, Seoul (KR); Kia Corporation, Seoul (KR)

(21) Appl. No.: 18/117,689

(22) Filed: Mar. 6, 2023

(30) Foreign Application Priority Data
Sep. 19, 2022 (KR) 10-2022-0117900

(51) Int. Cl. B60L 53/62; B60L 53/66; B60L 53/68; B60L 58/12

(52) U.S. Cl. CPC B60L 53/62; B60L 53/66; B60L 53/68; B60L 58/12; B60L 2240/70

(57) ABSTRACT

A method and a system for providing error history information for an eco-friendly vehicle charger. The method according to an embodiment of the present disclosure including the steps of: collecting information on a connected charger, when a vehicle is connected to any charger; receiving a notification of a communication compatibility conflict from the connected charger or determining whether an error is generated while performing communication with the connected charger; and transmitting problem occurrence information on the connected charger to a server based on the information on the connected charger, when receiving the notification of the communication compatibility conflict from the connected charger or a communication error occurs, wherein the problem occurrence history information on the connected charger in the server is updated based on the problem occurrence information on the connected charger.

### CROSS REFERENCE TO RELATED APPLICATION

The present application claims priority to Korean Patent Application No. 10-2022-0117900, filed on Sep. 19, 2022, the entire contents of which is incorporated herein for all purposes by reference.

### BACKGROUND

### Technical Field

The present disclosure relates to connectivity, and more particularly to a method and a system for managing an error history of an eco-friendly vehicle charger provided on a connectivity platform.

### Description of the Related Art

The global market environment and government-led supply of electric vehicles are growing. However, problems are still arising due to the lack of charging infrastructure. Various issues are being raised, including a conflict on charging between consumers, and concerns over power outages, especially as the power supply capacity of apartment houses is usually less than 100 kW. When ten slow chargers (usually 7 kW) are operated simultaneously, the use of public electric equipment such as lifts may be restricted, leading to severe cases such as power outages. In particular, the power outage issue may be worsened in the era of the third-generation electric vehicle capable of ultra-fast charging (350 kW). The electric vehicle, charger, and charging infrastructure capable of ultra-fast charging are essential to expanding the electric vehicle market. In the case of internal combustion engines, the average time consumed to fuel the vehicle is approximately 7 minutes, and the consumers are familiar with such services. The revitalization of the electric vehicle market can be achieved by reducing charging time and providing differentiated services to consumers who are familiar with internal combustion engines. Therefore, the automobile industry develops vehicles capable of ultra-fast charging, and related industries also are developing ultra-fast chargers. Accordingly, the conflict caused by charging time can be solved to some extent, but building the infrastructure used for the power supply required for ultra-fast charging is still a challenge. For example, assuming that five electric vehicles are capable of 350 kW ultra-fast charging simultaneously, the charging infrastructure that can handle such output is extremely insufficient. There is a limit to only increasing the power capacity of electric vehicle charging stations or extending the existing power lines.

Recently, charging infrastructure has been expanded with the widespread of electric vehicles. However, even if the charger is outdated or malfunctions due to poor management, it is inconvenient for the electric vehicle user to visit the charging station to charge the electric vehicle without knowing such a fact.

Accordingly, in the present technical field, when an error occurs with the eco-friendly vehicle charger, there is a need for the technology to provide information on the issue to a driver is required.

### SUMMARY

Therefore, the present disclosure has been made in view of the above problems, and it is a technical object of the present disclosure to provide information to a driver when an error occurs in an eco-friendly vehicle charger.

Another technical object of the present disclosure is to update charging communication compatibility status information between a vehicle and a charging station in real-time by using vehicle data, and to provide the information to a driver.

To accomplish the above objects, according to one aspect of the present disclosure, there is provided a method including the steps of: collecting, by a processor in response to a vehicle being connected to any charger, information on the connected charger; receiving, by the processor, a notification of a communication compatibility conflict from the connected charger or determining, by the processor, whether an error has occurred while performing communication with the connected charger; and transmitting, by a communication unit, error information on the connected charger to a server based on the information on the connected charger in response to receiving the notification of the communication compatibility conflict from the connected charger or determining the communication error has occurred, wherein error history information on the connected charger in the server is updated based on the error information on the connected charger.

Here, the error information may include location information and identifier information of the information on the connected charger.

Here, the identifier information may be a media access control (MAC) address.

Here, the method may further include: receiving, by an input and output (I/O) unit, first location information and first error history information on at least one first charger within a predetermined first threshold distance from a current location of the vehicle or a specific point selected by a user from the server; displaying, by the input and output (I/O) unit, the first location information and the first error history information on a display screen of the vehicle; determining, by the processor, whether information on charger selection is input from the user based on the first location information and the first error history information displayed on the display screen; and performing, by the processor, route guidance based on the information on the charger selection input from the user.

Here, the error history information may include information on a cumulative number of communication compatibility conflicts or communication errors between the first charger and other vehicles that occurred within a certain period of time based on a current time.

Here, the determining of whether the information on the charger selection is input includes determining, by the vehicle, that the charger selection has not been received in response to the vehicle having not receive an input from the user within a predetermined time selecting a charger or having received an input for an additional search for another charger.

Here, the method may further include receiving, by the communication unit in response to the information on the charger selection from the user is not input, a second location information and a second error history information of at least one second charger except for the first charger within a second threshold distance farther than the predetermined first threshold distance from the current location of the vehicle or a specific point selected by a user from the server.

Here, the second threshold distance may be set based on the state of charge of a battery mounted in the vehicle.

In addition, a vehicle according to an embodiment of the present disclosure includes: a processor, when the vehicle is connected to any charger, collecting information on the connected charger, and receiving a notification of a communication compatibility conflict from the connected charger or determining whether an error has occurred while communicating with the connected charger; and a communication unit transmitting error information about the connected charger to a server based on the information on the connected charger when receiving the notification of the communication compatibility conflict from the connected charger or an error has occurred, wherein error history information on the connected charger in the server may be updated based on the error information on the connected charger.

Here, the error information may include location information and identifier information about the connected charger.

Here, the identifier information may be a media access control (MAC) address.

Here, the communication unit may further include an input/output (I/O) unit receiving a first location information and a first error history information on at least one first charger within a predetermined first threshold distance from a current location of the vehicle or a specific point selected by a user from the server, and displaying the first location information and the first error history information on a display screen of the vehicle.

Here, the processor may determine whether information on charger selection is input from the user based on the first location information and the first error history information displayed on the display screen and perform route guidance based on the information on the charger selection input from the user.

Here, the first error history information may include information on a cumulative number of communication compatibility conflicts or communication errors between the first charger and other vehicles that occurred within a certain period of time based on a current time.

Here, the processor determines that charger selection has not been received when the information on the charger selection is not received from the user within a predetermined time or an input for additional search for another charger is received.

Here, the communication unit receives, when the information on the charger selection from the user is not input, a second location information and a second error history information of at least one second charger except for the first charger within a second threshold distance farther than the predetermined first threshold distance from the current location of the vehicle or a specific point selected by a user from the server.

Here, the second threshold distance may be set based on a state of charge of a battery mounted in the vehicle.

In addition, a system according to an embodiment of the present disclosure includes: a vehicle collecting receiving a notification of a communication compatibility conflict from a connected charger or determining whether an error has occurred while communicating with the connected charger, and transmitting error information on the connected charger to a server based on the connected charger when receiving a notification of a communication compatibility conflict from the connected charger or a communication error occurs, and the server, wherein the server receives the error information on the connected charger from the vehicle, updates error history information for the connected charger stored in memory or database based on the error information received from the vehicle, and transmits location information and error history information for at least one other charger within a predetermined threshold distance from a current location of the vehicle or a specific point selected by a user when receiving a request for information on an eco-friendly vehicle charger from the vehicle.

Here, the error information may include location information and identifier information about the connected charger.

Here, the identifier information may be the MAC address.

According to various embodiments of the present disclosure described above, when an error occurs in the electric vehicle charger, information thereof may be provided to a driver.

In addition, it may update charging communication compatibility status information between a vehicle and a charging station in real time by using vehicle data and providing the information to a driver.

Advantages which may be obtained in this specification are not limited to the aforementioned advantages, and various other advantages may be evidently understood by those skilled in the art to which the present disclosure pertains from the following description.

### BRIEF DESCRIPTION OF THE DRAWINGS

FIG. 1 shows a system for providing error history information for an eco-friendly charger according to an embodiment of the present disclosure.

FIG. 2 shows an example in which charging station information and charger error history information received from a server through a display screen of a vehicle or a terminal is provided.

FIG. 3 shows a method for providing error history information for an eco-friendly vehicle charger according to an embodiment of the present disclosure.

### DETAILED DESCRIPTION

Hereinafter, embodiments of the present disclosure will be described in greater detail with reference to the accompanying drawings. In describing the present disclosure, for ease of understanding, the same reference numerals are used to denote the same components throughout the drawings, and repetitive description on the same components will be omitted. In the following description, with respect to constituent elements used in the following description, suffixes “module” and “unit” are given in consideration of only facilitation of description and do not have meaning or functions discriminated from each other. In addition, in the following description of the embodiments disclosed in the present specification, a detailed description of known functions and configurations incorporated herein may be omitted when it may make the subject matter of the embodiments disclosed in the present specification rather unclear. In addition, the accompanying drawings are provided for a better understanding of the embodiments disclosed in the present specification and are not intended to limit technical ideas disclosed in the present specification. Therefore, it should be understood that the accompanying drawings include all modifications, equivalents and substitutions within the scope and spirit of the present disclosure.

Terms such as “first” and “second” may be used to describe various components, but the components should not be limited by the above terms. In addition, the above terms are used only for the purpose of distinguishing one component from another.

It will be understood that when a component is referred to as being “connected to” or “coupled to” another component, it may be directly connected to or coupled to another component or intervening components may be present. In contrast, when a component is referred to as being “directly connected to” or “directly coupled to” another component, there are no intervening components present.

As used herein, the singular form is intended to include the plural forms as well, unless context clearly indicates otherwise.

In the present application, it will be further understood that the terms “comprises,” “includes,” etc. specify the presence of stated features, integers, steps, operations, elements, components, or combinations thereof, but do not preclude the presence or addition of one or more other features, integers, steps, operations, elements, components, or combinations thereof.

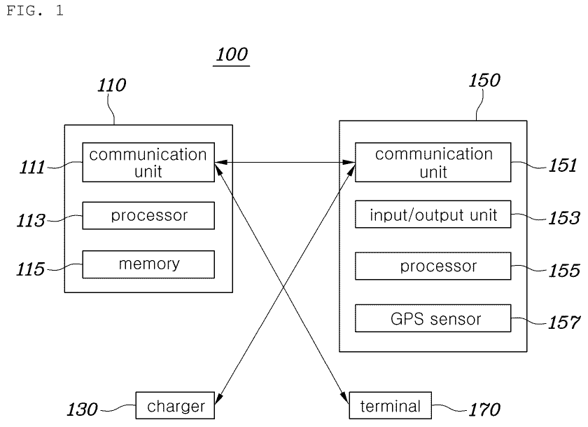

FIG. 1 shows a system for providing error history information for an eco-friendly charger according to an embodiment of the present disclosure.

Referring to FIG. 1, the system for providing error history information for an eco-friendly charger according to an embodiment of the present disclosure includes: a server 110, a charger 130, a vehicle 150, and a terminal 170.

The server 110 manages information on the eco-friendly vehicle charger, and includes a communication unit 111, a processor 113, and a memory 115.

The communication unit 111 receives error information on the charger 130 from the vehicle 150 in order to provide the eco-friendly error history information.

In addition, when the communication unit 111 receives a request for information on the eco-friendly vehicle charger within a predetermined threshold range from the current location or a specific location from the vehicle 150 or the terminal 170, the communication unit transmits the information to the vehicle 150 or the terminal 170.

The processor 113 updates the error history information on the charger 130 stored in a memory 115 or database (not shown) based on the received error information of the charger 130. The processor 113 may be implemented in the form of hardware, software, or a combination of hardware and software, or may be implemented as microprocessor.

The memory 115 stores information on the charger 130.

Here, the information on the eco-friendly vehicle charger may include location information of a charger, error history information of a charger, and an identifier information of a charger.

Here, the identifier information may be the MAC address.

Here, the error history information may include information on the cumulative number of communication compatibility conflicts or communication errors between the charger and vehicles that occurred within a certain period of time based on the current time.

For example, the error history information may include information on the number of communication compatibility conflicts or communication errors with respect to a specific charger in the past month.

In this case, the server 110 may separately provide the number of times the communication compatibility conflict occurred and the number of times the communication error occurred to the vehicle 150 or the terminal 170, respectively, and may provide a sum of the number of times.

In this case, the error history information of the charger provided to the vehicle 150 or the terminal 170 from the server 110 may be provided via the audio, video, and navigation (AVN) of the vehicle 150, or may be provided via location information application or route guidance application installed in the vehicle 150 or the terminal 170.

The charger 130 supplies power to the vehicle 150 and communicates with the vehicle 150 when connected to the vehicle 150 via a charging cable or the like.

In this case, the charger 130 may be a charger for the eco-friendly vehicle; for example, the charger 130 may be a DC COMBO fast charger or a slow charger for an electric vehicle.

In this case, the charger 130 verifies the communication compatibility with the vehicle 150. When there is a communication compatibility conflict with the vehicle 150, the charger 130 transmits a notification signal to the vehicle 150.

In this case, the notification signal may be a message according to a controller area network (CAN) standard.

The vehicle 150 receives the eco-friendly charging station information and error history information of the charger from the server 110, and outputs the received information.

Here, the received information may be displayed on the display screen or output via the voice guidance.

The vehicle 150 includes a communication unit 151, an input/output (I/O) unit 153, a processor 155, and a global positioning system (GPS) sensor 157.

The communication unit 151 communicates with the server 110 or the charger 130. For example, the communication unit 151 receives information on the communication compatibility conflict or the communication error of the eco-friendly vehicles from the server 110, and in the case of the communication compatibility conflict occurred when connecting with the charger 130, the notification thereof is received from the charger 130.

In this case, the notification signal may be a message according to a controller area network (CAN) standard.

In addition, the communication unit 151 receives the notification of the communication compatibility conflict from the charger 130, or in the case of the error occurring in the communication with the charger, the error information on the charger 130 is transmitted to the server 110 based on the information on the charger 130.

In addition, the communication unit 151 receives location information and error history information for at least one first charger within a predetermined first threshold distance from the current location of the vehicle or a specific time point selected by the user from the server 110.

In this case, the vehicle 150 may output the location information and error history information on the first charger and input the information on the charger selection among the first chargers for the route guidance via the I/O unit 153.

Here, the communication unit 151 may receive, when the information on the charger selection from the user is not input, the location information and error history information of at least one second charger except for the first charger within a second threshold distance farther than the first threshold distance from the current location of the vehicle or a specific point selected by a user from the server 110.

Here, the second threshold distance may be set based on the state of charge of the battery mounted in the vehicle 150.

The communication unit 151 may be a hardware device implemented with various electronic circuits to transmit and receive signals through a wireless or wired connection. The communication unit 151 may include a CAN communication module, a Near-Field Communication (NFC) chip, an NFC antenna, a Bluetooth module, a Wi-Fi module, a Long-Term Evolution (LTE) communication module, a 5G communication module, and the like.

The I/O unit 153 receives the user input for the user to search the eco-friendly vehicle charger or outputs the information on the communication compatibility conflict or the communication error of the eco-friendly chargers received from the server 110. The I/O unit 153 may be a device that has software, firmware, hardware (e.g., memory, processor), or a combination of them, which causes the device to perform the actions disclosed herein. The software may include one or more instructions that when executed cause the I/O unit 153 to perform the actions.

In this case, the information on the communication compatibility conflict or the communication error may be output via the display screen, the voice guidance, or the like installed in the vehicle.

The processor 155 searches the information on nearby chargers and the chargers installed in the charging station from the server 110 when the vehicle 150 requires charging or when a user input for a search for the charger is received from the user. The processor 155 may be implemented in the form of hardware, software, or a combination of hardware and software, or may be implemented as microprocessor, and may be, e.g., an electronic control unit (ECU), a micro controller unit (MCU), or other subcontrollers mounted in the vehicle.

In addition, when the charger 130 is connected to the processor 155 via the charging cable, the processor 155 collects information on the connected charger 130.

In this case, the information on the charger 130 may include the global positioning system (GPS) information and the identifier information of the charger.

Here, the identification information may be the MAC address.

In addition, the processor 155 receives the notification of the communication compatibility conflict from the charger 130 or determines whether the error has occurred while communicating with the charger 130, and when it is determined that the notification of the communication compatibility conflict is received from the charger 130 or the error has occurred during the communication, the communication unit 151 is controlled, thereby transmitting the information on the charger 130 and the communication compatibility conflict or the communication error to the server 110.

In addition, the processor 155 receives the location information and error history information on at least one first charger within a predetermined first threshold distance from the current location of the vehicle 150 or a specific point selected by the user from the server 110 by the communication unit 151, and determines, when the location information and error history information for the first charger are displayed on the display screen, whether information on a charger selection is input from the user based on the location information and error history information displayed on the display screen by the I/O unit 153.

In this case, the processor 155 may perform the route guidance based on the information on the charger selection input from the user.

The processor 155 may determine that the charger selection has not been input when the information on charger selection is not received from the user within a certain period of time or when an input for an additional search for another charger is not received.

The error history information may include information on the cumulative number of communication compatibility conflicts or communication errors between the first charger and other vehicles that occurred within a certain period of time based on the current time.

The global positioning system (GPS) sensor 157 may receive information on the current location of the vehicle from the GPS satellite. Accordingly, when the vehicle 150 is connected to the charger 130 via the charging cable, the GPS sensor 157 may receive the information on the location of the charger 130 connected to the vehicle 150 from the GPS satellite.

The terminal 170 receives the eco-friendly vehicle charger information and error history information of the charger from the server 110, and outputs the received information.

The received information may be displayed on the display screen or output via the voice guidance.

The terminal 170 may be applied to various terminal devices, including a smartphone, a portable terminal, a mobile terminal, a foldable terminal, a personal digital assistant (PDA), a portable multimedia player (PMP), a telematics terminal, a navigation device, a personal computer, a notebook computer, a slate PC, a tablet PC, an Ultrabook, a wearable device, e.g., a smartwatch, a smart glass, a head-mounted display (HMD), a WiBro terminal, an Internet protocol television (IPTV) terminal, a smart TV, an audio video navigation (AVN) terminal, an audio/video (A/V) system, a flexible terminal, a digital signage device, and the like.

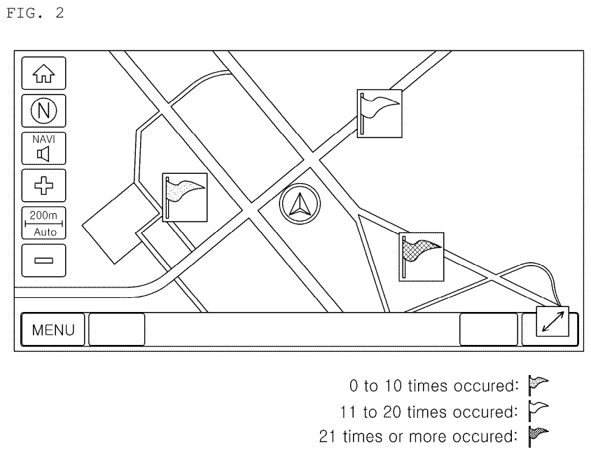

FIG. 2 shows an example in which charger and charger error history information received from a server through a display screen of a vehicle 150 or a terminal 170 is provided.

Referring to FIG. 2, the vehicle 150 or the terminal 170 of the user may display information on the error history for the eco-friendly vehicle charger located nearby or a specific location of the vehicle 150 on which the map is displayed. In this case, the information on the number of communication compatibility conflicts or communication errors in a certain past period of time may be displayed on the display screen. For example, the display screen of the user may display the number of communication compatibility conflicts or communication errors of the charger in the past month by dividing the number of times, i.e., 0 to 10 times, 11 to 20 times, and 21 times or more, in different colors or patterns of different flags.

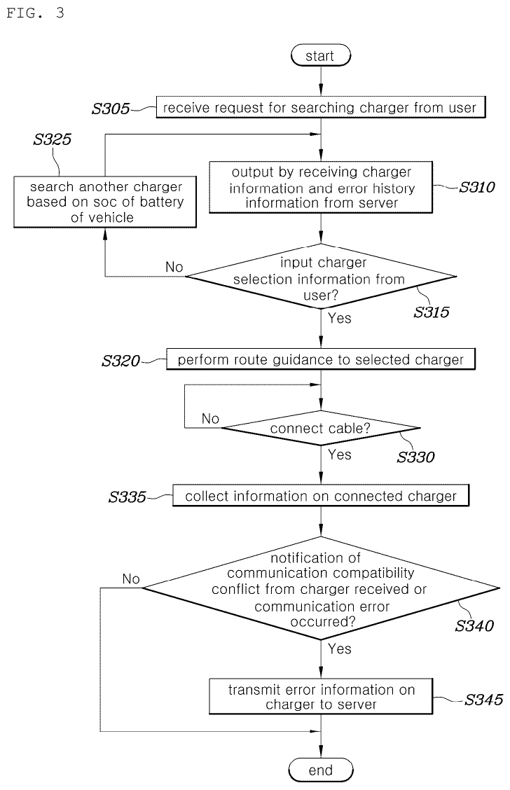

FIG. 3 shows a method for providing error history information for an eco-friendly vehicle charger according to an embodiment of the present disclosure.

Referring to FIG. 3, the vehicle receives a request for searching the eco-friendly vehicle charger from the user (S305).

In this case, the vehicle receives the request for searching for the eco-friendly vehicle charger based on the current location information of the vehicle or receives the location information on a specific point for searching for an eco-friendly vehicle charger from the user and receives the request for searching for the eco-friendly vehicle charger based thereof.

In this case, the request for searching for the eco-friendly vehicle charger may be received via a touch display screen installed in the vehicle.

Next, the vehicle outputs the retrieved information on the location information and error history information received from the server (S310).

Here, the retrieved charger may be at least one of the chargers within a predetermined threshold range from the current location of the vehicle or a specific point selected by the user.

In this case, the vehicle transmits the location information of the current vehicle or the location information on the specific point selected by the user to the server, and in response thereto from the server, the current location of the vehicle or the specific point selected by the user within a predetermined first threshold distance, and receives the location information of at least one first charger and the error history information for each of the chargers.

Here, the received information may be displayed on the display screen or output via the voice guidance.

Here, the error history information may include information on the cumulative number of communication compatibility conflicts or communication errors between at least one of chargers and other vehicles that occurred within a certain period of time based on the current time.

For example, the error history information may include information on the number of communication compatibility conflicts or communication errors with respect to a specific charger in the past month.

In this case, the vehicle may receive information on all chargers within a predetermined first threshold distance based on the current location of the vehicle, or a specific location selected by the user from the server and output information on the error history of chargers installed in the charger.

For example, the vehicle may receive information on all chargers within a radius of 5 km based on the current location and information on the error history of chargers installed in the charger and display the information on the display screen.

Next, the vehicle determines whether the charger selection is input from at least one of the retrieved chargers by the user (S315), and when one charger is selected by the user, a route guidance is performed to the selected charger (S320).

On the other hand, when the vehicle does not receive a selection for one of the chargers retrieved by the user, the vehicle searches for another charger based on the state of charge (SOC) of the battery installed in the vehicle (S325), and receives the outputs charger information and charger error history information retrieved from the server (S310).

Here, when the vehicle does not receive an input for selecting a charger from the user within a predetermined time or receiving an input for additional search for another charger, the vehicle may determine that the selection for the charger is not received.

In this case, the vehicle may receive location information and error history information of at least one second charger except for the first charger within a second threshold distance farther than the first threshold distance based on the current location or a specific location selected by the user and output information thereof.

Here, the second threshold distance may be set based on the SOC of the battery mounted in the vehicle.

Meanwhile, the vehicle may terminate the route guidance when the vehicle arrives at the charger.

The vehicle determines whether the vehicle is connected to any of charger and cable (S330), and collects information on the connected charger when the vehicle is connected to the charger (S335).

Here, the vehicle may collect the location information of the charger and the identifier information of the charger.

Here, the identifier information of the charger may be the MAC address of the charger.

Here, the location information of the charger may be received from the GPS sensor installed in the vehicle, and may receive the identifier information of the charger from the charger.

On the other hand, the vehicle may receive a notification of the communication compatibility conflict from the charger or determine whether a communication error has occurred (S340), and when the communication compatibility conflict notification is received from the charger or the communication error has occurred, the error information on the charger is transmitted to the server (S345).

In this case, to continue with charging the battery, the battery may perform a fail-safe operation.

By receiving the error information on the charger from the vehicle, the server may update the error history information on the charger stored in the memory or the database.

According to embodiments of the present disclosure described above, when an error has occurred in an electric vehicle, the information thereof may be provided to the driver.

In addition, it may update charging communication compatibility status information between a vehicle and a charger in real time by using vehicle data and providing the information to a driver.

The present disclosure mentioned in the foregoing description may be implemented as code that can be written to a computer-readable recording medium and can thus be read by a computer system. The computer-readable medium may include all kinds of recording devices in which data readable by a computer system is stored. Examples of computer-readable medium includes hard disk drive (HDD), solid state disk (SSD), silicon disk drive (SDD), ROM, RAM, CD-ROM, magnetic tape, floppy disk, optical data storage device, and the like. Therefore, the above embodiments are therefore to be construed in all aspects as illustrative and not restrictive. The scope of the present disclosure should be determined by the appended claims and their legal equivalents, not by the above description, and all changes coming within the meaning and equivalent range of the appended claims are intended to be embraced therein.

What is claimed is:

1. A method comprising:
collecting, by a processor in response to a vehicle being connected to any charger, information on the connected charger;
receiving, by the processor, a notification of a communication compatibility conflict from the connected charger or determining, by the processor, whether an error has occurred while performing communication with the connected charger; and
transmitting, by a communication unit, error information on the connected charger to a server based on the information on the connected charger in response to receiving the notification of the communication compatibility conflict from the connected charger or determining the error has occurred,
wherein error history information on the connected charger in the server is updated based on the error information on the connected charger.

2. The method of claim 1, wherein the error information comprises location information and identifier information about the connected charger.

3. The method of claim 2, wherein the identifier information is a media access control (MAC) address.

4. The method of claim 1, further comprising:
receiving, by an input and output (I/O) unit, first location information and first error history information on at least one first charger within a predetermined first threshold distance from a current location of the vehicle or a specific point selected by a user from the server;
displaying, by the input and output (I/O) unit, the first location information and the first error history information on a display screen of the vehicle;
determining, by the processor, whether information on charger selection is input from the user based on the first location information and the first error history information displayed on the display screen; and
performing, by the processor, route guidance based on the information on the charger selection input from the user.

5. The method of claim 4, wherein the first error history information comprises information on a cumulative number of communication compatibility conflicts or communication errors between the first charger and other vehicles that occurred within a certain period of time based on a current time.

6. The method of claim 4, wherein the determining of whether the information on the charger selection is input includes determining, by the vehicle, that the charger selection has not been received in response to the vehicle having not receive an input from the user within a predetermined time selecting a charger or having received an input for an additional search for another charger.

7. The method of claim 4, further comprising receiving, by the communication unit in response to the information on the charger selection from the user is not input, a second location information and a second error history information of at least one second charger except for the first charger within a second threshold distance farther than the predetermined first threshold distance from the current location of the vehicle or a specific point selected by a user from the server.

8. The method of claim 7, wherein the second threshold distance is set based on a state of charge (SOC) of a battery mounted in the vehicle.

9. A vehicle comprising:
a processor collecting information, when the vehicle is connected to any charger, on the connected charger, and receiving a notification of a communication compatibility conflict from the connected charger or determining whether an error has occurred while performing communication with the connected charger; and
a communication unit transmitting error information on the connected charger to a server based on the information on the connected charger when receiving the notification of the communication compatibility conflict from the connected charger or when a communication error has occurred,
wherein error history information on the connected charger in the server is updated based on the error information on the connected charger.

10. The vehicle of claim 9, wherein the error information comprises location information and identifier information about the connected charger.

11. The vehicle of claim 10, wherein the identifier information is a media access control (MAC) address.

12. The vehicle of claim 9, wherein the communication unit further comprises an input/output (I/O) unit receiving a first location information and a first error history information on at least one first charger within a predetermined first threshold distance from a current location of the vehicle or a specific point selected by a user from the server, and displaying the first location information and the first error history information on a display screen of the vehicle.

13. The vehicle of claim 12, wherein the processor determines whether information on charger selection is input from the user based on the first location information and the first error history information displayed on the display screen, and performs route guidance based on the information on the charger selection input from the user.

14. The vehicle of claim 12, wherein the first error history information comprises information on a cumulative number of communication compatibility conflicts or communication errors between the first charger and other vehicles that occurred within a certain period of time based on a current time.

15. The vehicle of claim 13, wherein the processor determines that charger selection has not been received when the information on the charger selection is not received from the user within a predetermined time or an input for additional search for another charger is received.

16. The vehicle of claim 13, wherein the communication unit receives, when the information on the charger selection from the user is not input, a second location information and a second error history information of at least one second charger except for the first charger within a second threshold distance farther than the predetermined first threshold distance from the current location of the vehicle or a specific point selected by a user from the server.

17. The vehicle of claim 16, wherein the second threshold distance is set based on a state of charge (SOC) of a battery mounted in the vehicle.

18. A system comprising:
a vehicle receiving a notification of a communication compatibility conflict from a connected charger or determining whether an error has occurred while performing communication with the connected charger, and transmitting error information on the connected charger to a server based on the information on the connected charger when receiving the notification of the communication compatibility conflict from the connected charger or a communication error occurs, and
the server, wherein the server receives the error information on the connected charger from the vehicle, updates error history information for the connected charger stored in memory or database based on the error information received from the vehicle, and transmits location information and error history information for at least one other charger within a predetermined threshold distance from a current location of the vehicle or a specific point selected by a user when receiving a request for information on an eco-friendly vehicle charger from the vehicle.

19. The system of claim 18, wherein the error information comprises location information and identifier information about the connected charger.

20. The system of claim 19, wherein the identifier information is a media access control (MAC) address.
